(19) United States
(12) Patent Application Publication
(10) Pub. No.: US 2006/0218228 A1
(43) Pub. Date: Sep. 28, 2006

(54) CLIENT PLATFORM ARCHITECTURE

(75) Inventor: Imad MOULINE, Braintree, MA (US)

Correspondence Address: SMITH FROHWEIN TEMPEL GREENLEE BLAHA, LLC, P.O. BOX 88148, ATLANTA, GA, 30356, US

(73) Assignee: SECURITY FIRST TECHNOLOGIES CORP, Atlanta, GA (US)

(21) Appl. No.: 10/907,199

(22) Filed: Mar. 24, 2005

(51) Int. Cl. G06F 15/16

(52) U.S. Cl. 709/203

(57) ABSTRACT

A client platform architecture enabling workstations to operate in an ASP type environment, but reap the benefits available to a rich or fat client. The client platform interfaces to a server and receives an image of its operational software from the server using JNLP or OSGI technology. The client device the necessary processing power and software to perform requested tasks regardless of whether the server is online or offline. Thus, the client device is fully or substantially fully functional without the need to interface to the server. The server contains the same functionality as is loaded into the client device and thus, can support thin clients. Any changes to the server software are subsequently loaded into the client platform.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

This invention relates to the field of distributed computer systems and, more particularly to implementing an ASP based distribution system in a low-error and high-reliability environment.

In the early days of distributed computing, systems typically employed the use of mainframe computers to perform back end processing and users of the computer system simply utilized dumb-terminals that would be communicatively connected to the main frame. The dumb-terminals simply acted as an input to control the mainframe through the use of a key board and an output to display computed results through a monitor. In the late 1970's and early 1980's technology advances brought about the use of personal computers that were instrumental in off loading some of the processor requirements of the mainframe computers and brought the processing power to the users work station.

Upon the introduction of the Microsoft Disk Operating System (MSDOS) operating on an Intel based microprocessor platform, the personal computer migrated into a stand alone system. The advantages of the mainframe computers included the ability to share resources, such as processing power, memory storage, applications and data. The advantages of the personal computers included the ability to obtain significant processing power at a relatively inexpensive price in comparison to mainframe computers, as well as minimizing maintenance and the need for system operators. However, in many environments there was a need for both capabilities.

As technology advanced, networking solutions came into existence that blended both worlds. Users could utilize personal computers but still gain the benefit of shared resources through the use of a central server running networking software such as Novell.

Today we have sophisticated technology that allows personal computers to be networked through globally reaching networks, sharing resources, applications, data and enabled to communicate with each other. As is typical with most technological advancements, many additional issues arise as the technology is employed in various environments. Issues faced by companies or businesses employing the use of distributed computing include reliability, upgrading the technology or application programs, security, network connectivity and the like.

Within financial institutions, such as banking companies, the issues surrounding the deployment of distributed computing are quite evident. Conventionally, teller systems were developed as rich clients using native technology. The rich clients carry substantial maintenance cost in that each system must be individual maintained, upgraded and serviced. With the advent of web-based applications, there is a shift in many industries to move native applications to web-based applications. However, in a banking environment, such a technology migration is not readily feasible because the use of web-based applications pose significant problems for bank branch teller devices.

Three are at least three fundamental requirements for such a teller system: accuracy, efficiency and customer focus.

Accuracy directly reflects on the effectiveness of a teller system. Several techniques have been proven effective to ensure accuracy for teller systems. One such technique is interactive validation. Interactive validation is focused on preventing a teller from entering inaccurate data into the system as soon as possible. Another technique is simplified transaction presentation. Simplified transaction presentation focuses on simplifying the encapsulation of a transaction to help ensure accuracy.

Efficiency is another fundamental requirement for teller systems. The main focus of efficiency is minimizes the amount to time it takes a teller to perform his or her tasks. Thus, efficiency can directly translate into shorter queues at the teller counter, which further translates into more transactions per teller and better customer service. Thus, banks are very focused on increasing the efficiency of the teller system. Banks have found that at least three key characteristics can have a significant impact on efficiency.

First of all, keyboard based systems are preferred. Tellers are typically extremely efficient with the use and operation of a keyboard. With the introduction of new technologies such as a mouse or other pointing instruments, the teller efficiency is adversely affected. Secondly, because tellers are very efficient at entering information into the teller system, the employment of in-screen updates and/or validations can adversely affect the teller's efficiency. For instance, if the teller must wait for the network to validate the entered data and update the screen at periodic intervals, the typical teller must wait for the response from the network. Thus, utilizing such techniques to improve the accuracy of the data is diametrically opposed to maintaining efficient operation. Thus, any technique that utilizes such a validation technique should not block the user from entering transaction data. Another characteristic that adversely affects efficiency is the use of screen scrolling. When the teller is required to use scroll bars or other similar techniques to view other portions of an input screen, implementers have determined that the tellers are more prone to make mistakes.

Finally, customer focus is a third fundamental requirement for teller systems. Banks are increasingly starting to look at branches as more than just customer convenience centers. Instead, branch offices are perceived to become sales advisory centers, with every interaction with the customer as a potential opportunity to up-sell or cross-sell additional services or products. Consequently, banking centers are striving to implement other features in the teller systems that will enable the teller systems to provide:

Integration across channels;

A unified customer view across all interactions;

Service inherent in all transactions; and

Advice based sales.

Terms of art that are used in the industry to describe systems such as teller systems include the terms “thin-client’ and “rich-client”. Thin-clients and rich-clients represent two ends of a spectrum of system sophistication. They both carry their own complexities in implementation within a teller system.

A rich-client is typically a personal computer or other device with significant computing capabilities that operates on a network. The rich-client is designed to operate with or without access to the server or a backend/mainframe system. It usually uses internal memory and processing power to run one or more applications locally on the client. Thus, a rich-client tends to operate autonomously utilizing its own resources, computing power, etc.

A thin-client traditionally was equivalent to a dumb-terminal but today, is more accurately described as a device that runs on a network and is designed to access a server for most of its functions. Typically a browser renders the user interface for the application described in HTML. A Web server delivers these HTML pages and performs actions on behalf of the user. Thus, the thin-client heavily relies on the processing power and resources of the server and generally is based on a web-architecture.

Within a teller system, the use of a thin-client poses several complexities, including but not limited to the following issues:

In-screen updates. Typically, teller transactions have data that gets updated based on other data entered in the screen. A good example would be calculating fees or loan rates. Implementing transactions using a web-architecture and thin-client would mean either a round-trip to calculate fees, or the business rules captured in scripting. Both are expensive—the former is time-intensive, because it blocks the user while calculating fees. The latter has higher costs, maintaining business rules in multiple locations.

Hot keys. Hot keys improve teller efficiency by improving the speed of transaction invocation. A web-based architecture provides little control over specifying and managing hot keys. In addition, any implementation of hot keys over a web-based architecture imposes significant time delays on teller operation.

Edit Masks. Edit masks are used effectively for syntactic validation of a field. They disallow any inaccurate character to be entered into a field. In web-applications, handling such syntactic validation requires the teller to wait until the next roundtrip (i.e., sending information to the server and waiting for the server to respond). This dramatically decreases the efficiency of the teller.

In-field validation. Field level validation can be done to handle complex syntactic and simple semantic validations. Such measures are effective in stopping the user from leaving a field with bad data. An example could be the expiration date which should be a value that is at least greater than today's date. Like with edit-masks, to implement such validations requires a communication roundtrip.

In-screen validation. Complex cross-field semantic validations can be captured while a transaction is submitted. However, performing such actions in the closest possible tier ensures better teller performance. In web architecture, this needs to be done in the server, while a rich-client could perform this validation on the client, without a network roundtrip.

Offline data. Commonly used data can be cached in the client to improve the responsiveness of the application. For example, in a cross-currency foreign exchange buy-sell, the list of valid “to”-currencies is computed based on the availability of cross-rates from the “from”-currency. In a web application, this would demand a roundtrip and consequently will block the teller from entering data, thereby increasing the time it takes to enter this transaction.

Disconnected mode. A rich client provides an ability to operate even when the network access to the server/host is unavailable. In a web application based on thin-clients, this can be exceedingly difficult to accomplish.

Maintaining session with peer devices. When working with peer-to-peer devices like printers, CDMs, peer-clients, etc., it may be necessary to retain the state of a transaction across multiple screens. This would be quite a challenge in a web-based environment. One example in which it is important maintain the state of a transaction across device and user interactions would be printing on a passbook printer, wherein one might need a user interaction requesting the user to insert the next page of the passbook.

Security in device interactions. Using an applet to manage peer-to-peer device interactions would pose some serious security risks that need to be overcome as well. Particularly, when the device deals with cash—like the Recycler and Cash Dispenser.

The following are several complexities that a rich-client architecture presents in building a teller system.

Deployment. The biggest complexity with a rich-client is managing installation and updates. Each rich-client workstation needs to be individually managed and updated. This tremendously increases the deployment cost of the system.

Maintenance. During a life span of a system, the bank might want to update business processes, introduce new transactions and incorporate learning as validations into the system. But, the ability to perform such maintenance updates to the system becomes complex in a rich-client environment, as the updates have to be pushed to the client one by one.

Portal participation. As the service-based transaction delivery becomes a common theme, banks are increasingly looking to consolidate role-based workplace front-end for the teller. With a web-client it is rather straightforward to build applications so that they can be organized into portlets. With the rich client technology, this is exceedingly difficult.

According to industry analysts, banks are poised to spend more than $550 million on branch renewal in 2004. This number will most likely increase for coming years as technology advances. Banks are adding new technology to their branches, with plans to significantly enhance operational efficiencies, increase customer satisfaction and capture new revenue-generating opportunities. There are many options available with thin-client and rich-client infrastructures, and the decision is made all the more daunting when one considers that branch decisions could be a 10- to 20-year investment. Thus, it is imperative for banks to take a close look at the pros and cons of each technology to determine how to obtain the best of both worlds. Fat-client applications are full-blown applications, residing on the bank's workstation infrastructure, which provide users with full access to the workstation's resources. These fat-client applications have full control over the user interface, allowing for well-designed user interfaces to be highly optimized and efficient and reach across the network only for resources that may not be available on the user's workstation, making the applications more impervious to network outages and reducing the load on shared servers. However, fat-client applications are expensive to deploy and maintain, and often create complex data synchronization issues for a bank's IT staff. These shortcomings have for years motivated the ongoing development and enhancement of thin-client applications—applications that run on a browser, live on a server or farm of servers and require limited client-side processing power. One of the greatest advantages of thin-client environments is the ability to significantly streamline deployment and costs, because thin-client applications do not have to be rolled out on every workstation. Additionally, incremental changes can be deployed more frequently because they can be deployed centrally. At the same time, thin-client environments have significant shortcomings as well: they severely limit the efficiency of the user interface and the level of service delivered to customers; they limit programming control; and their performance and availability are less predictable than fat-client environments, as they rely on servers across the network for most of the resources to get the job done. For example, any time a user interface changes significantly, such as when a user is navigating from screen to screen, a thin client is required to go across the network to the server, which will compute what the next screen should look like; this round trip adds time to teller transactions in an environment where every second and key stroke count. A fat client, on the other hand, creates and renders the UI locally, without dependence on a trip to the server.

Thus, there is a need in the art for a teller system that can take advantages of the positive aspects of both the thin-client and the rich-client and eliminate or alleviate the disadvantages of both. Further, there is a need in the art for such a system to provide offline operation with minimal degradation in performance.

### SUMMARY OF THE INVENTION

The present invention is directed towards providing a smart client that, among other things, satisfies the above-listed needs in the art. In the various embodiments described, functionality and off-line capabilities that are available for rich-client platforms are merged with the ease of upgrade and maintenance available for thin-client platforms. Advantageously, the various embodiments of the present invention are particularly suitable for implementing teller systems in a banking environment.

In various embodiments of the present invention, the client is primarily a java based rich-client system, where the deployment and maintenance are managed by a deployment protocol such as, but not limited to, java Network Launching Protocol (JNLP) or Open Services Gateway Initiative (OSGI.).

In a JNLP oriented embodiment of the present invention, the client can employ a zero-deployment model by using a reference implementation of JNLP called Java WebStart. Java WebStart is an easy to use, free program installer that comes bundled with java runtime environment version 1.4 (JRE). Java WebStart provides a one-click activation to download, cache and maintain the code-base, providing options to automatically integrate with the desktop. WebStart can handle multiple Java runtime environments. Such embodiments of the present invention can utlize JRE 1.4 to run the client. JRE is the minimum standard Java platform for running applications written in the Java programming language. It contains the Java Virtual Machine, Java core classes, and supporting files. Once a user has installed the JRE, it can be used to run any number of applications written in the Java

In an OSGI oriented embodiment of the present invention, the client may utilize Eclipse RCP. Such an embodiment maintains code over OSGI and renders screens using the Standard Widget Toolkit (SWT). Such an embodiment showcases the portal participation capability aspect of the present invention and can utilize the IBM Workplace Client Technology (WCT) to achieve integration across multiple portals from different applications on the front-end.

Aspects of the present invention enable banks to tap into the power, performance and availability of fat-client applications, all while reaping the efficiencies and cost-saving benefits of thin client applications. The present invention is suitable for the banking environment, in which growing competitive pressures force banks to drive down the costs of their system support, upgrades, maintenance and product rollouts. By application of the present invention, banks do not have to deploy applications at each teller workstation manually. Changes to policies, procedures and new product rollouts can be made once at a single location, but will be reflected at all workstations; this administrative shortcut alone can save a bank a substantial sum of funding. The modern day role of bank branches is changing to be focused on relationship building—turning tellers into trusted advisors and giving them the tools to handle interactions as efficiently as possible. Aspects of the present invention enable banks to gain advantages like real-time screen updates, which minimize waiting time and maximize the opportunity to build customer relationships and cross-sell additional services.

Branch operations are mission-critical. Banks can't afford their teller systems to go down and have a line of customers wrapped around their branch office, waiting for a system to come back up. Aspects of the present invention not only enable tellers to continue performing transactions for customers when the server is down, but also automatically communicate the stored data back to the server once it comes back on-line. Additionally, the deployment of aspects of the present invention lower the risks faced by teller systems. Embodiments of the present invention can run in a well-defined and well-protected security sandbox and therefore, be less vulnerable to security liabilities. An application running on a platform employing aspects of the present invention can be isolated from other applications. This isolation enables banks to deploy and run multiple applications from multiple vendors that have differing requirements, and avoid, for example, the problems associated with the dynamic link library in the Windows environments and the Java Virtual Machine version—compatibility problem in the JAVA world.

Thus, aspects of the present invention, when incorporated into a teller environment, provide many advantages such as lowering the total cost of ownership, increasing competitive agility, providing greater customer service, allowing predictable operations availability and so on. But the value of aspects of the present invention is amplified within the context of a multi-channel integration strategy, since banks can create, implement and maintain products and processes once, and easily deploy updates across their enterprise. For example, if a customer approaches a teller requesting a funds transfer, the criteria for transferring funds is in the business logic within the bank's front office system. Within an integrated channel environment, a bank's information technology staff can build criteria logic once in a single location that applies to all desired funds transfer requests that come into not only the branch, but also via the call center and over the Internet. Additionally, a smart-client teller application enables a bank to easily extend the same funds transfer rules to off-line teller workstations without rewriting logic at the platform level.

From an infrastructure perspective, there are several standards-based approaches emerging and banks, of course, have the option to buy or build. In the JAVA world, there are applications that rely on the JAVA Network Launch Protocol, which allows applications to be distributed and updated easily. These JAVA systems can work on-line or off-line without being proprietary to any vendor. There are also some additional Microsoft-based technologies, such as ClickOnce, based on NET, and IBM's recently released Workplace Client Technology, as well as Eclipse 3.0 on the Rich Client Platform (RCP), which can enable vendors to build applications that provide banks with all the hybrid benefits addressed above. In addition, some providers have already developed standards—based client applications integrated on a common platform to help banks take advantage of the best of the fat-client and thin-client worlds. Aspects of the present invention provide a platform on which banks and other similar institutions can deploy such applications and thereby have a highly efficient, robust environment for providing client services.

### BRIEF DESCRIPTION OF THE DRAWINGS

FIG. 1 is a block diagram of an exemplary embodiment of the present invention.

FIG. 2 is a system diagram illustrating a typical scenario in which client device 100 can operate.

FIG. 3 is a flow diagram illustrating the steps and the timing involved in performing a portion of such a request with a thin client compared to the steps and timing involved with a client device working online and working offline and incorporating aspects of the present invention.

### DETAILED DESCRIPTION OF THE INVENTION

The aspects of the present invention are directed towards providing a smart client that enables the merging of functionality and off-line capabilities available for rich-client platforms with the ease of upgrade and maintenance available for thin-client platforms. In addition, aspects of the present invention allow for the integration of an ASP type model into an environment, such as a banking environment, in which the overall architecture of an ASP type model is not directly suitable due to, among other things, the lack of security and the round trip data delivery lags due to interfacing to a server. Additionally, aspects of the present invention facilitate the provision for the deployment of mission critical applications onto remote, front end, workstations. Thus, the present invention enables a front-end workstation to operate in an ASP type model in which the application programs can be seamlessly loaded into the workstation in such a manner that the workstation can retain near full functionality when working in an off-line mode, and that minimizes any data delivery times associated with the performance of various functions or transactions.

Turning now to the figures in which like numerals and labels refer to like elements, the various aspects and embodiments of the present invention are described in more detail.

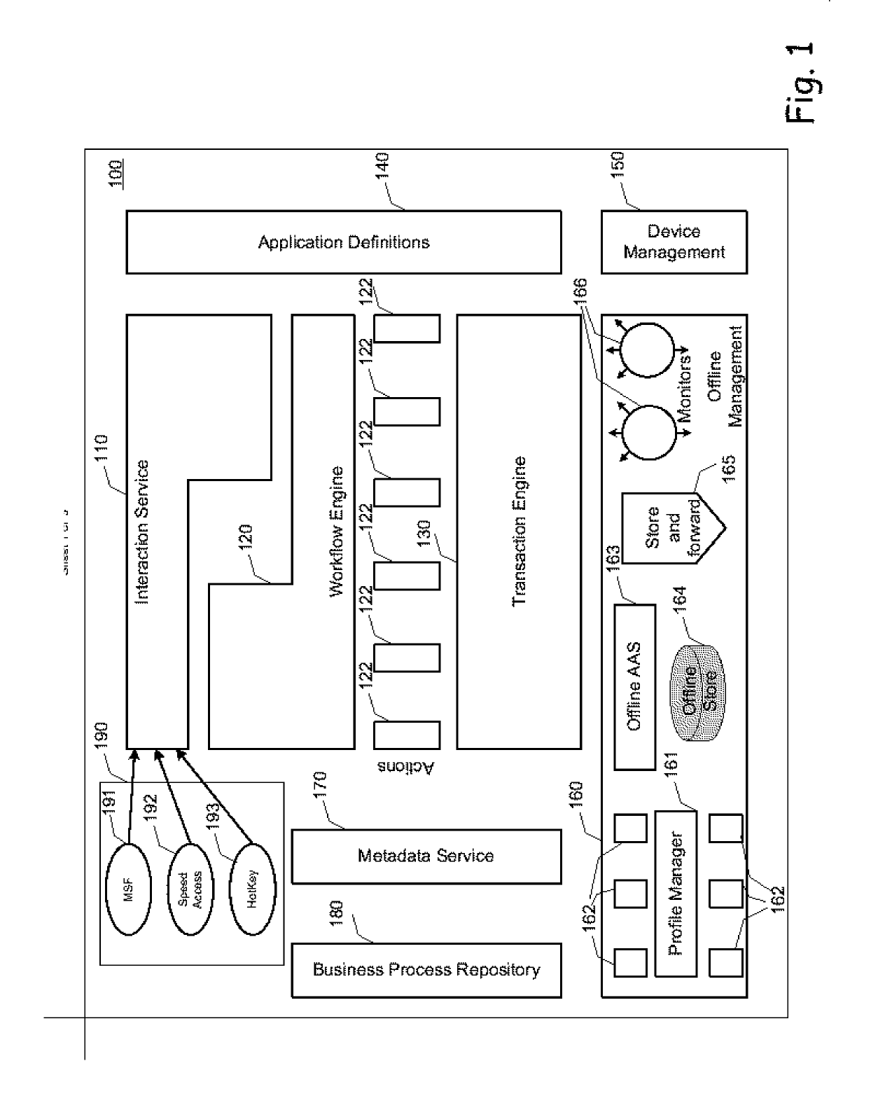

FIG. 1 is a block diagram of an exemplary embodiment of the present invention. The diagramed system is a typical client device that can be employed in various environments and implement various aspects of the present invention. The client device 100 includes an interaction service block 110, a workflow engine 120, a transaction engine 130, application definitions 140, device management block 150, offline management block 160, metadata service 170 and a business process repository 180 and client device interface 190. It should be understood that the particular structure illustrated in FIG. 1 and described herein is simply for illustrative purposes. The particular demarcation of the various functions and features can be described in a variety of manners, can be combined into a fewer number of blocks or separated out into a larger number of blocks.

A user, process or machine can interface to the client device 100 through the various interface mechanisms available through the client device interface 190. As illustrated, the client device interface can include a menu structure framework 191, speed access 192 and one or more hotkeys 193. Thus, for a user interacting with the client device 100, the user can select one or more hotkeys to invoke functions, enter repetitive data or the like. It should be understood that the client device interface 190 can include a variety of other input and output mechanisms including, but not limited to a display device, audio output devices, printers, mouse devices or other pointing devices, signature pads, keyboards or the like.

The interaction service block 110 processes any input received from the client device interface 190 and prepares the presentation of any data to be provided to the client device interface 190. The interaction service block 110 interacts with the workflow engine 120 to provide received data, requests, transactions, application invocations or the like, and receives response data from the workflow engine 120. More specifically, the interaction service block 110 is primarily responsible for the entire user interface of the client device 100. As such, the interaction service block 110 controls the graphical user interface, the menu structure framework and any other user-like interfaces to the client device 100. For instance, in a teller workstation environment, the interaction service block 110 may display a screen for performing a withdrawal. As the teller interacts with the bank customer, the teller can enter necessary information into the client device 100 by filling in particular fields in the withdrawal screen. The teller may enter a few items, such as the customer name, the account number and the amount of funds to be withdrawn. Upon completion of this information, the interaction service block 110 may generate an additional screen requesting further information. Once all of the information necessary to effectuate the withdrawal of funds, the interaction service block 110 can invoke a process to perform the withdrawal service.

The functions, applications or processes invoked through the interaction service block 110 are provided through cooperation of the workflow engine 120, the application definitions 140, the business process repository 180 and the metadata service 170. Each of these blocks cooperatively define and house the intelligence for providing the functionality of client device 100. The client device 100 can support a variety of functions and/or applications and, over a period of operation, the available functions and/or applications can be modified by either adding new functions, deleting functions, or augmenting or diminishing the functionalities of various functions and/or applications.

When the interaction service block 110 accumulates the necessary information to invoke a function or application, the interaction service block 110 calls the appropriate workflow function through the workflow engine 130. This process can include formatting the acquired information into the appropriate format and passing the acquired information to the workflow engine 130 as a function call, although it will be appreciated that other techniques for providing the acquired information to the workflow engine 130 could also be employed such as, but not limited to, pushing the data onto a stack or providing a pointer to the appropriate memory location within the interaction service block 110.

The application definitions 140 define, at a high-level, what transactions are available for the client device 100 at any particular time. In generating user screens, the interaction service block 110 interfaces to the application definitions 140 to generate a menu of selectable functions based on the current state of the client device 100. For instance, the home screen of the client device 100 may list a menu of operations, such as, withdrawal, funds transfer, balance checking, account creation, card issuance, etc. In generating this home screen, the interaction service block obtains the currently available functions from the application definitions 140. It should be appreciated that the interactions service block 110 may also obtain this list through the workflow engine 120 without having to directly interface with the application definitions 140.

The application definitions 140 may also house the definitions for various hot-keys and speed access codes. For instance, a teller may invoke a funds transfer by pressing a single hot key (i.e., Function 9) which results in invoking the display of the withdrawal screen. The definitions for such hot-keys can reside within the application definitions 140.

The business process repository 180 maintains a library of processes, sub-routines, functions, or the like, and can best be described as a library of functions. When a function or application defined in the application definitions 140 is invoked, the workflow engine 130 operates to build a workflow process by extracting or invoking the functions or processes within the business process repository 180 in accordance with the definition of the function or application obtained from the application definitions 140.

The business process repository 180 describes the process to be performed. Each process within the business process repository 180 includes a collection of steps and business rules that are executed to perform the process. The steps may include further interactions with the customer or teller through the interaction service block 110, may invoke an action in cooperation with a backend server, may invoke a business rule that augments or modifies the process, or may include another process or sub-process. As an example, the following steps may be included in a process to request a funds withdrawal:

Step 1—Validate customer information process

Step 2—If customer balance is greater than $500 then go to Step 4, otherwise

Step 3—Invoke supervisor sign-off process

Step 4—Invoke funds withdrawal

The workflow engine 120 operates akin to a complier or interpreter. When an action is invoked through the interaction service block 110 or otherwise, the workflow engine 130 identifies the appropriate application definition in the application definitions 140 and pulls the necessary processes from the business process repository 180 to perform the action. As previously mentioned, the action may require additional interaction with the interaction service block 110. In such a situation, the workflow engine 120 communicates with the interaction service block 110 to modify or augment the user interface and obtain the necessary information, confirmations, etc. The workflow engine 120 also interacts with the transaction engine 130 to perform certain tasks. The workflow engine 120 creates actions 122 that are to be performed through the transaction engine 130. The workflow engine 120 can create multiple actions to be operated on by the transaction engine 130. For each such action, the workflow engine provides the necessary data, identifications and information required for the transaction engine 130 to perform the action. For instance, if the action is a request to perform a funds transfer, the action may include an identification of the customer, the amount of funds to be transferred, the account the funds are to be withdrawn from and the account into which the funds are to be transferred. In addition, the action may indicate that appropriate authorizations for conducting the action have been obtained.

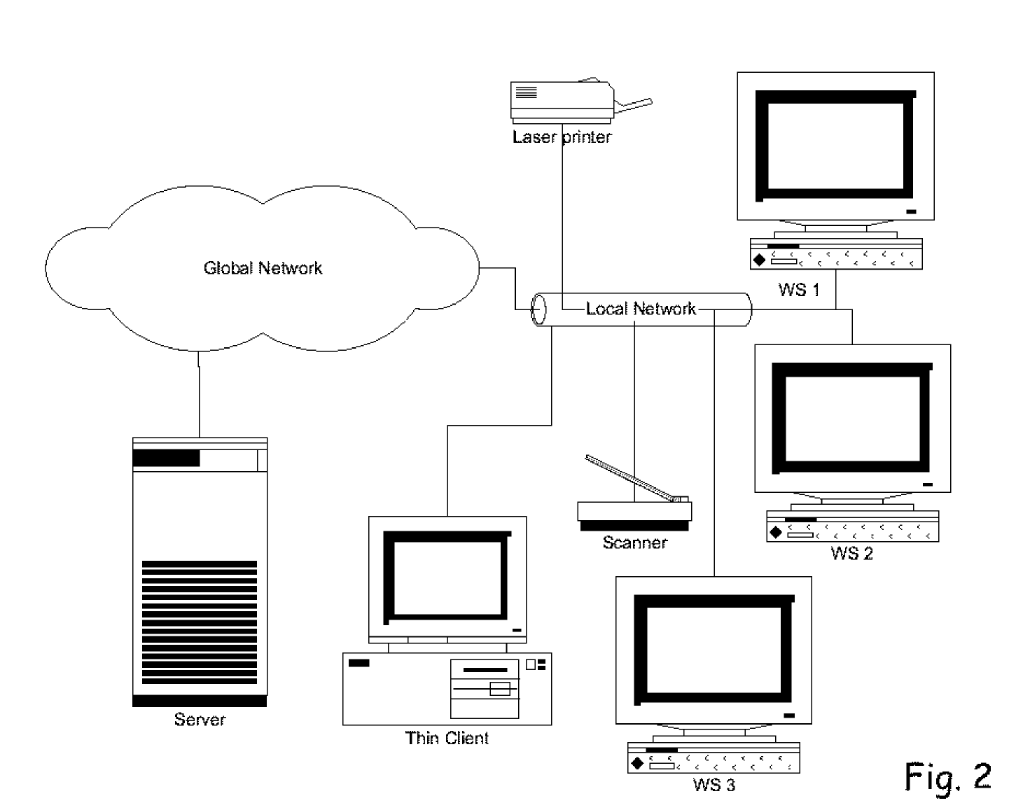

The transaction engine 130 operates differently depending on the mode of operation—on-line or offline. During on-line operation, the transaction engine 130 interacts with a server and during offline operation with the offline management 160. This operation will be described in more detail in conjunction with the discussion of the offline management 160 and with regards to FIG. 2. However, in general the transaction engine 130 operates in on-line mode to ensure that communication with the backend system or server is bundled appropriately, sequenced appropriately and verifies the execution. In the offline mode, the transaction engine 130 ensures that requested transactions are placed into the offline store and that the transactions are subsequently performed when online operations have resumed.

The metadata service 170 provides further customization to the available functionality of the client device 100. This aspect of the client device 100 allows various aspects and operations of the client device 100 to be easily modified without having to modify the core functionality of the application definitions 140 or the business process repository 180. For instance, the user screens can be easily modified or augmented through the use of the metadata service 170. Such augmentations could include the display of additional fields within the screen, on-line help notes to assist the completion of screens if and when it is determined beneficial. Another augmentation could be for providing additional information about a customer. If a workflow process requests all information about a typical customer, the hard-coded information about the customer can be extracted and, any additional information that may be required for the particular branch or company can be obtained by a query of the metadata service 170.

The device management 150 enables the client device 100 to interface with other devices that are connected through a local area network and manages such interactions. Any necessary device drivers for devices connected to the client device 100, either directly or over the local area network can be loaded into the device management 150. In addition, the device management 150 can discover devices that are accessible to the client device 100, ensure that the necessary drivers are in place, current and active, and verify that the devices are available. The device management 150 enables all communication with the client device 100 to be conducted on a peer-to-peer basis thus, allowing interaction with the devices even if the backend server or wide area network are not operating. The device management 150 performs simplistic operations such as acting as a buffer for printers, to more complicated operations such as managing the delivery of requests to various devices, ensuring proper sequencing of activities, filtering out redundant requests, and verifying messages are sent to and properly received by a device. As an example, if a teller requests a balance to be printed on a customer's passbook, the device management 100 can ensure that the request has been properly delivered to the printer and that the correct passbook has been placed into the printer.

FIG. 2 is a system diagram illustrating a typical scenario in which client device 100 can operate. The illustrated scenario includes three client devices 210, 212 and 214 that are communicatively connected over a local area network 220. Also residing on the local area network 220 is a printer 230, a scanner 240 and a thin client 250. The local area network 220 interfaces to a wide area network 260, such as the Internet, to gain access to a server 270. The server 270 is of similar construction, with regards to functionality, as the client device 100 illustrated in FIG. 1. Each of the processes and/or applications available in the client device 100 is first created on the server 270. The server 270 is able to operate in a multi-channel environment interfacing to both client devices 100, as well as thin clients such as thin client 250. The server is also operable to operate as the backend processor for the overall application, such as a banking operation, or alternatively, as the interface to the backend processor.

Each of the processes or applications available to the client device 100 are first created, and maintained within the server 270. When a virgin client device 100 is attached to the server 270 and powered up (for example client devices 210, 212 or 214), an image of the processes and/or applications available to the client device are loaded from the server. As functions or applications are modified, such changes take place on the server and are then uploaded to the client devices upon subsequent power ups or on the fly. It should be understood that the present invention requires only the portions of the processes or applications that have changed to be reloaded. Thus, the client devices are maintained and kept current by modifying a single platform—the server 270.

In operation, processes or applications that are invoked by the client devices operate as described above. However, if a thin client is attached to the local area network, the same functionality that is available to the client devices is available to the thin client. In the thin client scenario, rather than invoking actions through the cooperation of the application definitions 140, the business repository 170, the metadata service 130, the workflow engine 120 and the transaction engine 130, all located on the client device, mirrored counterparts of these functions residing in the server 270 are invoked.

Thus, upon applying power to a client device 100, all of the current processes and applications are loaded into the client device using technology such as JNLP or OSGI. Advantageously, the client devices house all of the functionality that is available on the server side and, can operate in an offline mode regardless of the availability of the server 270.

Offline Operation

Returning to FIG. 1, the offline management block 160 houses several aspects of the present invention. The offline management block 160, as well as the other functional blocks within the client device 100 are loaded upon initially bringing the client device 100 online, and can be subsequently updated throughout the life of the client device. The offline management block 160 includes a profile manager 161 that manages and maintains multiple profile definitions 162, an offline authentication and authorization service (ASS) 163, on offline store 164, a store and forward function 165 and activity monitors 166.

More specifically, the offline management block 160 enables the client device 100 to operate as a stand-alone device, yet reap the benefits of a highly integrated thin client platform. The majority of the functionality necessary for the client device to fully perform the necessary tasks is loaded into the offline management block. Upon powering up of a virgin client device 100, all of the functions necessary for the client device 100 to operate are loaded into the client device 100. Once fully loaded, the client device can operate in either an on-line or offline mode seamlessly. Thus, regardless of whether the client device 100 is attached to a network, or the backbone network is operating, the client device 100 is fully functional. Upon subsequent powering up of the client device 100, it is not necessary to load all of the functionality back into the client device 100. Rather, the client device can simply be checked and verified to determine if any upgrades or changes in the functionality of the client device 100 are necessary, and if so, only the portions of the functionality that have changed since the last power up or update are loaded into the client device 100.

The profile manager 161 maintains various user or access profiles 162. When a user or device attempts to access the client device 100, the profile manager 161 is invoked to determine the access privileges and functionality of the client device 100. For instance, in the teller environment, each teller may be given a profile. Alternatively, various classes of tellers may share a profile. The profile 162, regardless of the mapping to users, can establish the access and functionality for of the client device 100 for the accessing user or device. Thus, a junior teller that access the client device 100 may be limited to only access certain transactions, may be required to obtain a supervisor approval for other transactions and can be restricted based on other criteria such as hours of operation, value of transactions being processed, volume of transactions allotted for a particular period of time, amount of cash the teller is allowed to accumulate in the teller till drawer, etc.

The offline AAS 163 operates to authenticate and authorize requested services for offline operation. Thus, if the client device 100 is not able to communicate with the back end systems, the offline AAS 163 can verify that a request transaction can be approved. Such authentication and authorization is performed at a run-time level meaning that each and every access can be subjected to the scrutiny of the offline AAS 163. The offline AAS 163 also operates to verify the credentials of a user accessing the client device 100. Thus, prior to granting a teller access to the client device 100, the offline AAS 163 verifies that the client is authorized, and what levels of authorization are to be granted.

The AAS maintains three buckets of information: user level, terminal level and global level information. The user level bucket includes user specific data. This information includes, but is not limited to the authentication credentials of the various users and transactional data. The transactional data can include a running electronic journal of all transactions requested and/or performed by a user of the client device 100. For instance, the transactional data may include running totals of cash in and cash out for a specific teller, the amounts of foreign currency received, the number and types of transactions performed, etc. The terminal level bucket includes information specific to the particular client device 100. This information can include what devices are attached or are accessible to the client device 100, the hours of operation of the business in which the client device 100 operates and capabilities available to various users (i.e., junior tellers, senior tellers, supervisors, etc). The global level bucket includes information pertinent to each of the client devices in the system. For instance, fee structures for a branch or the bank in general can be stored in this bucket. Thus, as fees change on a regional basis, the various client devices can be updated accordingly. When the business process repository is creating processes for the workflow engine 120, the rules available in the AAS 160 can be accessed and incorporated into the workflow process.

The store and forward function 165 serves as the transaction communication point for offline operation of the client device 100. When transactions are received from the transaction engine 130, the transactions are properly formatted, authenticated by the offline AAS 163. If the client device 100 is presently in communication with the back end system, the transaction can be immediately sent for processing. However, in offline mode the transactions are then stored in the offline store 164. When the client device is back on-line, the store and forward function 165 extracts the transactions from the offline store and sends them to the backend server. The client device 100 can also utilize the offline store 165 and the store and forward function 165 during online operation to warehouse the various transactions in an effort to regulate bandwidth requirements or as a result of network congestion or to prevent server overrun. The store and forward function 165 delivers and updates information in a seamless manner so that the users are not aware that the client device 100 is working in an offline mode of operation.

The monitors 166 are configurable monitors. The intelligence for the operation of the monitors is loaded into the client device 100 from the server 270. Among other things, the monitors operate to monitor the activity of the client device 100 and provide alerts such as, determining if the server is reachable, is the host available, is the network up or down, etc. For instance, the monitors may monitor the network to detect when it is online and then invoke the store and forward function to begin the delivery of transactions. Thus, when certain monitored activities are detected, the monitors 166 may send out event notices to various other components within the client device 100. Such events can be used to modify the operation of the client device 100. For instance, if the client device is operating offline, the user interface may be modified to require additional or different information. More specifically, during online operation, a customer may simply be required to enter a customer identification to invoke a particular transaction. The client device 100, using the customer identification can obtain account information, such as account numbers, from the server 270 for that particular customer. However, in offline operation, the client device 100 may not be able to obtain the account information and thus, the user interface can be modified to require the customer to provide the account number rather than simply a customer identification.

The device management block 150 maintains a list of devices that can be accessed by the client device 100. For instance, if a client device 100 is to have access to a signature pad, a check printer and a cash dispenser, all of the information necessary to access and interface to these devices is loaded into the device management block 150. Thus, regardless of whether the client device 100 is operating in an on-line or offline mode, the client device 100 will have the necessary information to interface to these devices. This is true even if the devices are not directly connected to the client device 100 but rather, are accessed over a local network or IP network and are shared devices.

In operation, suppose that a branch office includes several work stations. Two of these work stations are to be granted access to a particular device (i.e. Printer One). The present invention allows the drivers for Printer One to be downloaded to these work stations in the background and automatically configures the Printer One for access by the work stations. Alternatively, the client device 100 can discover the device and configure the work stations to access the device.

Example of Operation

Some of the benefits and advantages of the present invention can be better appreciated through an example. In this example, a typical flow of processes necessary to perform a stop payment operation will be illustrated for both a thin client and the client device incorporating aspects of the present invention. Traditionally, to stop payment on a check, a customer was required to place a call to the call center of the bank and request stop payment for a particular check number or ranges of check numbers. Today, a customer can walk into a branch office and approach a teller with the same request.

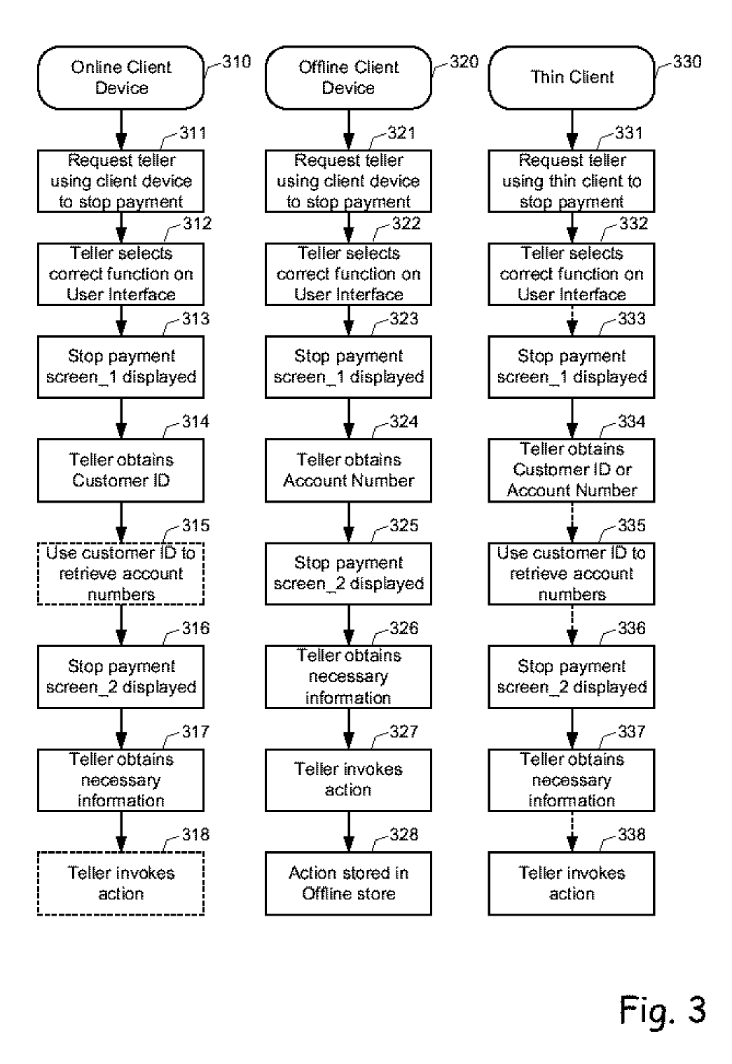

FIG. 3 is a flow diagram illustrating the steps and the timing involved in performing a portion of such a request with a thin client compared to the steps and timing involved with a client device working online and working offline and incorporating aspects of the present invention.

Flow 310 depicts typical steps involved for a client device 100 operating online. A customer approaches the teller using an online client device at step 311 to request a stop payment. The teller then invokes the client device 100 to select the stop payment function 312 displayed on the screen under the control of the interaction service block 110. The interaction service block 110 either then displays the first screen for the stop payment action 313 autonomously or, may send a request to the workflow engine 120 to invoke the action and thereby receive the first screen to be displayed. The first screen of the stop payment action may include indicators of what information the teller must obtain in order to further the process. Such information may include the input of the customer identifier (i.e., the customer's name, social security number, or their code). The teller obtains the customer identification and enters this information into the appropriate field of the first screen 314. Using the customer identifier, the client device 100 retrieves the account numbers for the customer 315. This is the first step in the process in which the online client device must interact with the server and thus, this block is illustrated using broken lines. The interaction service block 110 passes the customer identifier to the workflow engine 120, which then creates an action for the transaction engine 130. The transaction engine 130 then interfaces with the server to obtain the list of account numbers for the identified customer. The transaction engine 130 then passes this information to the workflow engine 120, which operates to either send a second screen to the interaction service block 110 or provides an indicator to the interaction service block 110 to display the second screen. The second screen is then displayed by the interaction service block 110 at step 316. The teller then obtains the necessary information from the customer to complete the transaction, such as a selection of the account, the identification of the check number, the party to whom the check was written, the amount of the check, etc. 317. It should be appreciated that several additional steps may be involved in this process but, for purposes of illustrating the difference in operation between the online client device, offline client device and the thin client, it is not necessary to elaborate further on these steps. Finally, one the teller obtains all of the necessary information, the teller invokes the stop payment action 318. Invoking the stop payment processes involves the workflow engine 120 creating an action for the transaction engine 130 which then interfaces with the server to send the transaction.

Flow 320 depicts the typical steps involved for a client device 100 operating offline to perform the same tasks as performed in flow 310. A customer approaches the teller using an offline client device at step 321 to request a stop payment. The teller then invokes the client device 100 to select the stop payment function 322 displayed on the screen under the control of the interaction service block 110. The interaction service block 110 then displays the first screen for the stop payment action 323 either autonomously or, may send a request to the workflow engine 120 to invoke the action and thereby receive the first screen to be displayed. The first screen of the stop payment action may include indicators of what information the teller must obtain to further process the stop payment. In this example, the information may include the input of the customer's bank account. In this particular embodiment, the account information for the customers is located on the server and thus, the client device 100 is not able to look up the customer account numbers based on the customer identifier. Thus, the first screen for the stop payment process requests for the offline operation requests the teller to obtain the account number rather than the customer identifier. The teller obtains the account number and enters this information into the appropriate field of the first screen 324. Either through invoking a workflow process through the workflow engine 120 or autonomously, the interaction service block 110 then displays the second stop payment screen 325. The teller then obtains the necessary information from the customer to complete the transaction, such as the identification of the check number, the party to whom the check was written, the amount of the check, etc. 326. It should be appreciated that several additional steps may be involved in this process but, for purposes of illustrating the difference in operation between the online client device, the offline client device and the thin client, it is not necessary to elaborate further on these steps. Once the teller obtains all of the necessary information, the teller invokes the stop payment action 327. Invoking the stop payment process involves the workflow engine 120 creating an action for the transaction engine 130 which then interfaces with the offline management 160. This interaction can involve storing the transaction into the offline store 164 for later retrieval by the store and forward function 165 and for later processing 328. It should be evident from this flow chart, that the client device 100 is able to perform all the necessary tasks while working in the offline mode of operation. The reader will also appreciate that the entire function was performed without the need for accessing the unavailable or offline server.

Flow 330 depicts typical steps involved for a thin client to perform the same operations as performed by the client device in flows 310 and 320. Initially, a customer approaches the teller using a thin client device at step 331 to request a stop payment. The teller then invokes the thin client to select the stop payment function 332 displayed on the screen under the control of the server. The server receives the request and then provides the first screen for the stop payment action 333 for the thin client to display. The broken line between step 332 and 333 indicates that the thin client must access the server for this function and thus, there is a delay incurred by sending the request to the server and receiving the display screen. The first screen of the stop payment action may include indicators of what information the teller must obtain in order to further the stop payment process. Such information may include the input of the customer identifier (i.e., the customer's name, social security number, or other code). The teller obtains the customer identification and enters this information in to the appropriate field of the first screen 334. Using the customer identifier, the thin client retrieves the account numbers for the customer 335. Again, this process involves the server and thus, incurs a delay in processing. The server then operates to send a second screen to the thin client. The second screen is then displayed by the thin client 336. The teller then obtains the necessary information from the customer to complete the transaction, such as a selection of the account, the identification of the check number, the party to whom the check was written, the amount of the check, etc. 337. It should be appreciated that several additional steps maybe involved in this process but, for purposes of illustrating the difference in operation between the online client device, offline client device and the thin client, it is not necessary to elaborate further on these steps. Finally, once the teller obtains all of the necessary information, the teller invokes the stop payment action 338. Invoking the stop payment process again involves an access to the server. Thus, it will be appreciated that the thin client requires a significant increase in the interaction with the server, does not provide for any offline operation, and is subject to several delays due to communications with the server.

The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons skilled in the art.

What is claimed is:

1. A method for deploying applications into workstations in a mission critical environment, the method comprising the steps of:
creating processes to run on a server, comprising:
a business process repository that contains a library of functions;
application definitions that identify available processes; and
a workflow engine that generates a workflow to perform a process request by identifying applications available in the application definitions and linking together appropriate functions from the business process repository;
interconnecting a plurality of workstations to the server using a wide area network;
loading an image of the server processes into each workstation upon virgin power up of the workstations;
receiving a process request at a workstation;
performing the process request on the workstation to create a transaction;
transmitting the transaction to the server; and
loading the changes incurred in an upgrade of one or more of the processes to each client device.

2. The method of claim 1, wherein the step of loading an image of the server processes into each workstation further comprises loading the business process repository, the application definitions and the workflow engine into each workstation.

3. The method of claim 2, wherein when the workstation is operating in an offline mode, further comprising the step of storing the transaction within the workstation and the step of transmitting the transaction to the server is performed when the workstation returns to an online mode of operation.

4. The method of claim 3, wherein the step of loading the changes incurred in an upgrade of one or more of the processes further comprises only loading the components that have been affected by the change.

5. A system for providing ASP type operation to a plurality of workstations connected to each other over a local area network and communicating with a server over a wide area network, the system comprising:
a server including a server-based processing function including a business process repository that contains a library of functions, application definitions that identify available processes; and a workflow engine that generates a workflow to perform a process request by identifying applications available in the application definitions and linking together appropriate functions from the business process repository;
each workstation including:
a user interface;
an interface to the server;
an offline manager that interacts with the server when the server is online; and
a client-based processing function that interacts with the user interface and the offline manager by:
receiving function requests from the user interface;
generating a process flow to perform the requested function, the process flow being generated based on an upload of information received from the server including the business process repository and the application definitions;
performing the requested function and providing a transaction to the offline manager;
the offline manager being operable to:
detect when the server is online; and
provide the transaction to the server.

6. The system of claim 5, wherein the client-based processing function is an image of the server-based processing function and upon virgin power up of each client device, the processing function is loaded into the client device.

7. The system of claim 6, wherein upon subsequent power ups of any client device, any changes that have been made to the server-based processing function are loaded into the client device.

8. The system of claim 7, wherein the loading of the processing function into the client devices is performed using JNLP technology.

9. The system of claim 7, wherein the loading of the processing function into the client devices is performed using OSGI technology.

10. The system of claim 5, wherein the server further includes a thin client interface and the server is operable to receive process requests from the thin client and to perform the requested functions.

11. The system of claim 5, wherein the processing function can bypass the offline manager when the server is online and directly interface to the server.

12. A server suitable for operation in support of a mission critical environment, the server comprising:
a business process repository that contains a library of functions;
application definitions that identify available processes; and
a workflow engine that generates a workflow to perform a process request by identifying applications available in the application definitions and linking together appropriate functions from the business process repository;
the server being operative to interconnect with a plurality of workstations using a wide area network and being further operative to:
load an image of the server processes into each workstation upon virgin power up of the workstations, thereby enabling each workstation to operate autonomous to the server to receive and process transactions;
receiving a processed transaction from a workstation, the transaction being received by the workstation and processed based at least in part on using the image of the server processes; and
loading the changes incurred in an upgrade of one or more of the processes to each workstation.
